(19) United States
(12) Patent Application Publication
(10) Pub. No.: US 2008/0039142 A1
(43) Pub. Date: Feb. 14, 2008

(54) Method for determining characteristics of an antenna path in a base station in a wireless communications network, a base station and a network

(76) Inventors: Donal Martin Curtis, Eckental (DE); Markus Ruether, Emskirchen (DE); Markus Schindler, Langenzenn (DE)

Correspondence Address: Lucent Technologies Inc.;Docket Administrator - Room 3J-219, 101 Crawfords Corner Road, Holmdel, NJ, 07733-3030, US

(21) Appl. No.: 11/503,332

(22) Filed: Aug. 11, 2006

(51) Int. Cl. H04B 17/00; H04B 1/38

(52) U.S. Cl. 455/561; 455/67.11

(57) ABSTRACT

A W-CDMA base station 2 includes a probe 16 for detecting the receive signal power. The output of the probe 16 is applied to a processor 23, which, in conjunction with a comparator 25, determines the minimum receive signal level. This represents the thermal noise level and is used to determine an offset used by the base station 2 when receiving communications traffic. The determined received signal level is used to report to a radio network controller the Received Total Wideband Power.

### FIELD OF THE INVENTION

The present invention relates to a method for determining characteristics of an antenna path in a base station in a wireless communications network, a base station and a network, and more particularly where the wireless network is a CDMA (Code Division Multiple Access) network, that is, a network which is based on CDMA technology, such as CDMA itself, CDMA2000 and W-CDMA, for example.

### BACKGROUND OF THE INVENTION

In a wireless communications network, it is necessary to know at what gain and in what frequency bands a base station is transmitting and receiving. This is particularly relevant for CDMA networks, where there is typically a requirement to correctly report Received Total Wideband Power (RTWP), for example. Deviation from specified values may lead to regulatory problems and also to practical difficulties in operating the network. The radio frequency characteristics of an antenna path at a base station have a significant effect on any signal transmitted or received via that antenna. The antenna path is the signal path between the base station transmitter and an antenna associated with that base station.

Each component included in an antenna path has an impact on its radio frequency characteristics. In determining the antenna path characteristics, to begin with, the response of each of the antenna path components, such as amplifiers, transmission lines, cables, diplexers and duplexers, is individually measured to establish the noise, gain and attenuation attributable to that component. Then this information is used to assess the combined effects of the components on any signal sent via that antenna path. Following this assessment, an offset can be set for the antenna path, to ensure that a signal sent via that path is confined to the allowed gain and within the specified frequency band allocation. To achieve optimum performance, a network controller will attempt to operate at close to the highest permitted gain, as determined from the measured antenna path characteristics.

In order to ensure compliance, it is necessary that the measurements of component operational performance be accurately made. This can involve considerable effort. Measurements must be taken for each antenna signal path, and, typically, a single base station has six, or even twelve, antenna paths.

The appropriate measurements may be made when the base station is first commissioned. However, it can be problematic to keep the information up to date to deal with changing parameter values as components age, suffer damage or when modifications are made. By their nature, base stations and their associated antennas may be somewhat inaccessible to field engineers. An antenna may be located on a mast placed on a roof of a building, for example. Negotiating access with building owners, and arranging for the base station to be shut down to enable measurements to be carried out in safety, may pose a challenge. The task in keeping measurement records up to date is onerous and it is difficult to effectively implement this for an entire network.

### BRIEF SUMMARY OF THE INVENTION

According to an aspect of the invention, a method for determining characteristics of an antenna path in a base station of a CDMA wireless communications network includes the steps of: measuring the receive signal power for the antenna path to determine the thermal noise level; and using the thermal noise level to determine an offset to be applied for communications traffic received via the antenna path. A CDMA wireless network is one that is based on CDMA technology, such as CDMA itself, CDMA2000 and W-CDMA, for example.

In contrast to the previous laborious techniques that have been used for many years, the present inventors have realized that it is not necessary to measure the gain, attenuation and noise data attributable to individual components in an antenna path to determine its radio frequency characteristics. It might be thought that detecting only the thermal noise level would be insufficient to enable the antenna path to be sufficiently well characterized. However, the inventors have realized that measuring only this single parameter is indeed sufficient, leading to a significant reduction in the effort involved.

The method may include determining the thermal noise level using a sensor incorporated in the base station circuitry. A suitable sensor is the probe for measuring receive signal level that is incorporated in a base station for detecting communications traffic. Thus, the invention may be implemented using a sensor that is already present in a base station, avoiding the need for redesign or retrofitting.

A measurement of the receive signal power to determine the thermal noise level may be readily carried out without the intervention of a field engineer to perform the measurement. This significantly reduces operational difficulties, as human access to the equipment is not required and the base station does not need to be shut down for measurements to be taken. Thus, it is more likely that the required measurements will be taken and that records will be kept up to date.

One method in accordance with the invention includes measuring the receive signal power over a time period to obtain a minimum signal. Thus, although there may be contributions to the receive signal power from other sources in addition to the thermal noise level, over time, the minimum signal will be representative of the thermal noise level, which includes any continuous in-band interference, as some measurements will be made when any in-band periodic interference is absent. This enables the estimate of the thermal noise level to become increasingly well defined, as measurements are taken over time, and any periodic disturbances leading to temporary higher received signal levels will be discounted.

A value representative of the minimum signal may be stored in a store, and then the stored value changed accordingly if a subsequent lower receive signal power is received. The stored value may be the minimum receive signal power or derived therefrom. For example, it may an offset calculated from the receive signal power minimum.

Conveniently, a method in accordance with the invention does not use measurements of the receive signal power when communications traffic from or to the base station is being sent via the antenna path. Although measurements may be taken during such times, the minimum receive signal power will not then be representative of the thermal noise level only, and so they are not useful in determining the thermal noise level. The timing for taking measurements may be arranged using knowledge of the traffic communications schedule of the base station, or alternatively, or in addition, by not taking measurements when the receive power signal exceeds a certain set value. This concept may be extended to avoid making measurements when there is active communications traffic involving neighboring base stations. Again, this may be determined by monitoring the receive signal power, so a threshold can be set which excludes both traffic transmitted and received by the antenna's own base station and also traffic associated with neighboring base stations. A radio network controller may alternatively, or in addition, supply the necessary information concerning neighboring base station operations.

By using the invention, the amount of human effort required to integrate UMTS base stations into a radio access network is reduced, both at the time of initial deployment, and at any later time when anything changes with respect to the hardware components which connect the base station to its antenna or antennas. Use of the invention eliminates the need to maintain exact and correct manually obtained records of the radio frequency characteristics of CDMA or W-CDMA antenna paths, for example. Decisions related to the antenna path characteristics may be made based solely on the received power value measured by a sensor, without requiring specific knowledge of the radio frequency hardware components physically located between the sensor and the antenna.

In one method in accordance with the invention, the stored value representative of the minimum signal is monitored, and, if it changes by more than a certain amount, a notification is sent to a network controller. This can be used to detect significant failures or changes to components in the antenna path, which may potentially require investigation by a field engineer. In addition, if the stored value changes by an amount greater than a certain level, a re-initialization may be carried out automatically. This may be done by setting the stored value to a start value from which a new minimum value is determined, enabling an offset to be determined which is relevant to the current condition of the antenna path.

In another aspect of the invention, a base station for a CDMA wireless communications network, comprises: a measuring circuit including a sensor operative to measure over a time period the thermal noise level in an antenna path to obtain its minimum value; calculating means for calculating an offset using the minimum value; a store for storing a value representative of the minimum value of the thermal noise level; and means for applying the offset to traffic reception via the antenna path.

In another aspect of the invention, a CDMA wireless network comprises: at least one network controller; and a plurality of base stations, each base station comprising: a measuring circuit including a sensor operative to measure over a time period the thermal noise level in an antenna path to obtain its minimum value; calculating means for calculating an offset using the minimum value; a store for storing a value representative of the minimum value of the thermal noise level; and means for applying the offset to traffic reception via the antenna path, and each base station further comprising means for reporting to the network controller data derived from the measured thermal noise level. The reported data may relate to Received Total Wideband Power, or, for example, it could be information about a change in the thermal noise level that exceeds a threshold change.

### BRIEF DESCRIPTION OF THE DRAWINGS

Some methods and embodiments in accordance with the present invention will now be described by way of example only, and with reference to the accompanying drawings, in which:

FIG. 1 schematically illustrates a CDMA network in accordance with the invention;

FIG. 2 schematically illustrates a base station included in the network of FIG. 1 and in accordance with the invention;

FIG. 3 is a graph schematically illustrating a signal received by the base station of FIG. 2;

FIG. 4 schematically illustrates operation of the base station shown in FIG. 2 in accordance with the invention; and

FIG. 5 schematically illustrates another base station, and associated antenna arrangement, in accordance with the invention.

### DETAILED DESCRIPTION OF THE DRAWINGS

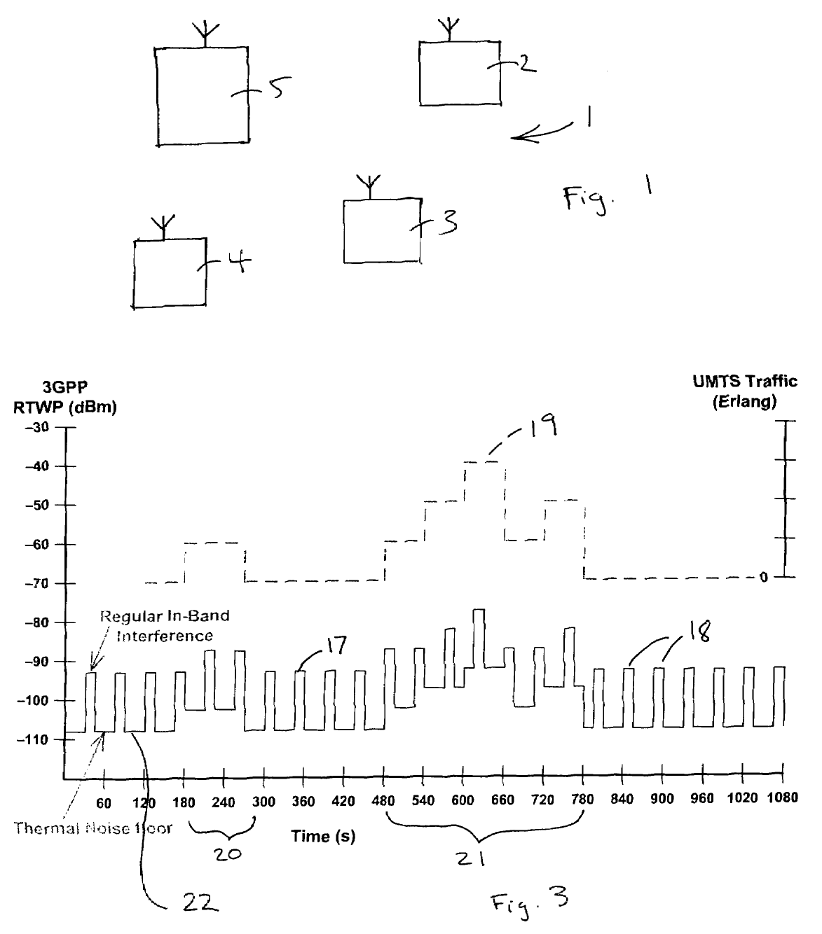

With reference to FIG. 1, a W-CDMA wireless communications network 1 includes a plurality of W-CDMA base stations 2, 3 and 4, only some of which are shown, which communicate with a radio network controller (RNC) 5. Typically, a network includes many RNCs and base stations over an extensive geographical area. Control and fault management of the network is performed by means of an associated Operations and Maintenance (O&M) system. Although this example relates to a W-CDMA network, it should be understand that the invention is similarly applicable to other types of CDMA network.

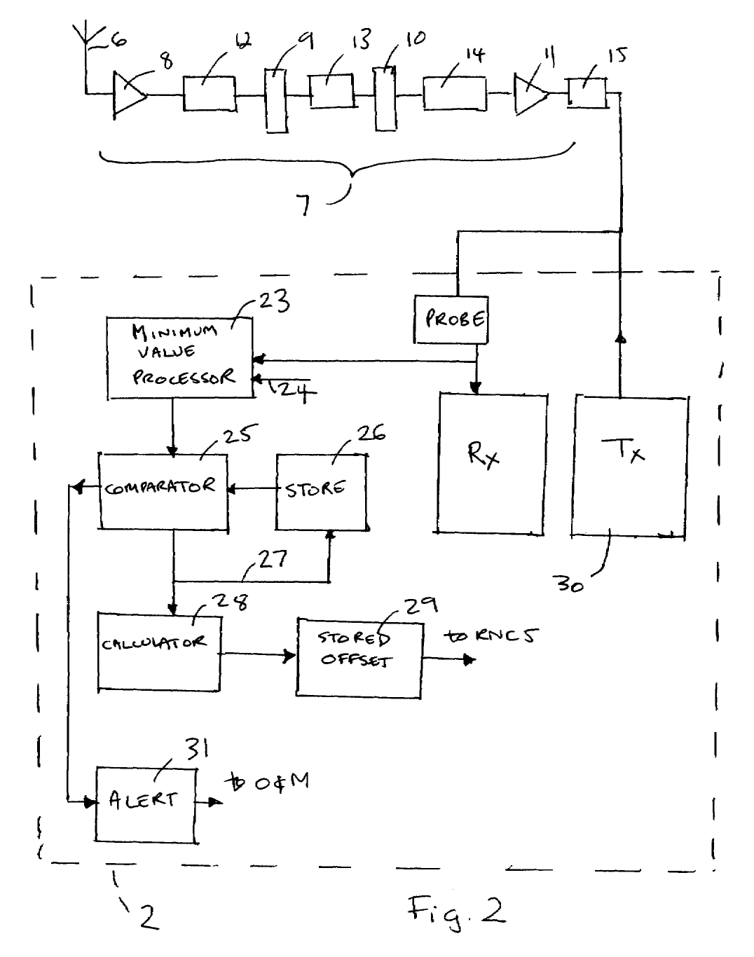

A base station 2 and an associated antenna 6 are shown schematically in FIG. 2. An antenna path 7 includes the antenna 6 itself, a tower-mounted amplifier 8, diplexer 9, duplexer 10, antenna-system amplifier and distributor 11, and the lines and cables 12 to 15 which connect them. Communications traffic is transmitted from the base station 2 along the antenna path 7 and received at the base station 2 via the antenna path 7 also. A probe 16 is included in the base station 2 and detects the receive signal power to give an output which is applied to receiver circuitry 17. The receiver circuitry 17 is conventional and thus is not further described.

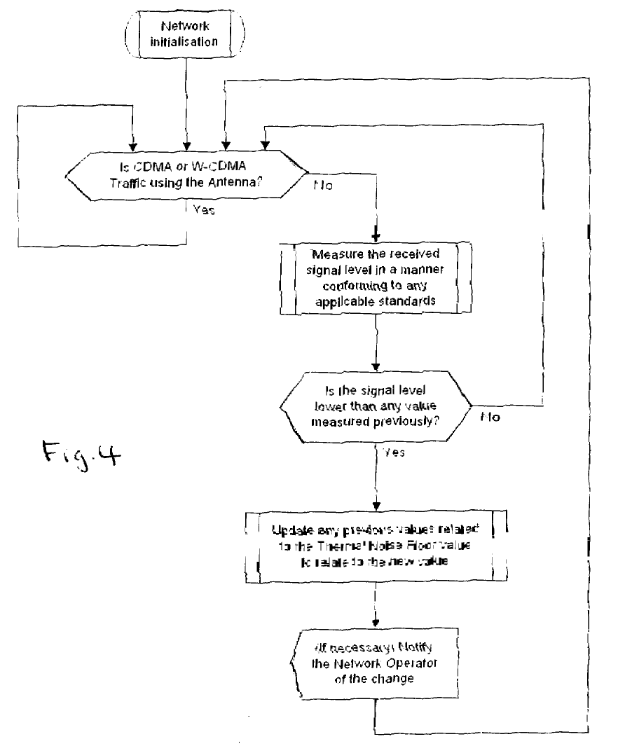

An example of a typical signal received at the probe 16 is shown in FIG. 3. The receive signal power, also termed the receive signal level, is shown by the solid line 17 representing the signal detected by the probe 16, which is a calibrated sensor. A periodic in-band interference causes regular spikes 18 in the receive signal power. There is also some UMTS traffic that is detected by the probe 16 and which is shown by the broken line 19. The effect of this on the receive signal power is apparent during the time period 20, from 180 seconds until 270 seconds, and also at the time period 21, from 480 seconds until 780 seconds. The minimum signal 22 of the receive signal power is the thermal noise level.

As shown in FIG. 2, the output of the probe 16 is applied to a minimum value processor 23. If W-CDMA traffic is being received or transmitted by the base station 2, an inhibit signal is applied on line 24 to the processor 23. The inhibit signal may be derived from knowledge of the communications schedule of the base station 2 and/or by detecting when the receive signal power is indicative of traffic being received. When traffic transmission or reception ceases, the processor 23 is enabled. It measures the received signal level and applies the result to a comparator 25, which carries out a comparison with a stored value held in store 26. If the current value is greater than, or equal to, that held in the store 26 then there is no output from the comparator 25.

If the comparator 25 finds that the current value is smaller than that held in the store 26, the current value is applied on line 27 to update the store 26 with the new minimum value which is representative of the thermal noise level. In addition, the current value is applied to a calculator 28 to calculate an offset, which is held in another store 29. The updated offset derived from the thermal noise level is used when reporting the received total wideband power to the RNC 5.

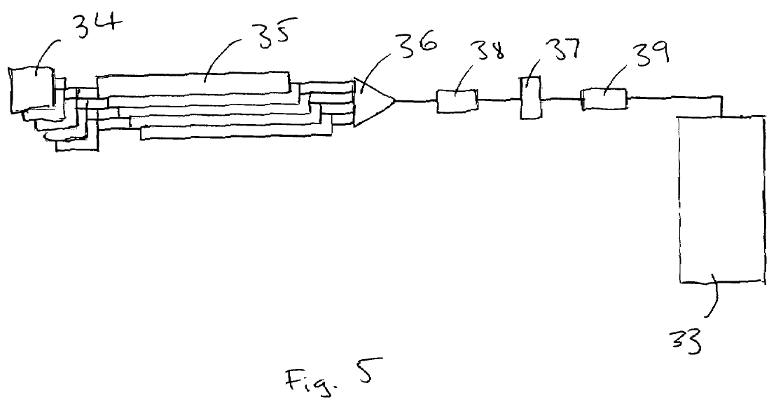

The diagram of FIG. 4 illustrates the steps involved in determining the radio frequency characteristics of the antenna path 7.

If the comparator determines that the receive signal level deviates from the value held in the store 26 by an amount greater than an acceptable amount, it sends an alert signal to alert circuit 31. If the alert state persists for longer than a pre-set time, an alert is sent to the network's Operations and Maintenance (O&M) system.

Each antenna path in the base station 2 is analyzed in a similar manner, and an appropriate offset calculated for each one.

In summary, using knowledge of the value of the physical constant of thermal noise power at the receive frequency and W-CDMA receive bandwidth, and given knowledge of the amount of the communications traffic present on the W-CDMA receive path, the lowest receive signal power level measured over time is used to obtain an offset.

### Offset(dB)=(Receive signal level at the probe)−(Thermal noise at the antenna)

For the periods where no CDMA2000 or UMTS traffic is present on the W-CDMA receive path, the lowest receive signal power levels measured relate directly to the value of the physical constant of thermal noise level, offset by any constant in-band interference due to non-periodic non-CDMA2000 or non-UMTS transmitters within the W-CDMA receive bandwidth.

The lowest values of receive signal power level measured are used to set internal base station antenna path parameter values such that the base station will always report W-CDMA receive power levels with a base value of the physical constant of thermal noise power.

Continuous in-band interference due to non-periodic non-CDMA2000 or non-UMTS transmitters with frequencies within the W-CDMA receive bandwidth is taken into account when determining the offset, as it is included as a contribution to the lowest measured receive signal power level values.

In the embodiment illustrated in FIG. 2, an inhibit signal is sent via line 24 to the processor 23 when W-CDMA traffic is using the antenna path. In another embodiment, the processor 23 itself determines when such traffic is present by detecting the raised levels of receive signal power. If such raised levels are detected, it delays measurements until the traffic ceases. Another embodiment may make use of a combination of these methods.

Also, in the embodiment illustrated in FIG. 2, when measurements are being made, such measurements are effectively taken continuously. In other embodiments, measurements may be taken at distinct intervals, which may be regular or irregular intervals.

With reference to FIG. 5, a CDMA base station 33 is similar to that described with reference to FIG. 2. However, in this case, it has a distributed antenna system path, with multiple antenna adaptors 34 and multiple transmission lines 35 connected to an antenna-system amplifier and distributor 36. The antenna path also includes a diplexer 37 and jumper cables 38 and 39. The base station 33 operates in a similar way to that shown in FIG. 2 and thus is not described in detail. A measurement of the receive signal power is made by a probe incorporated in the base station 33 and is sufficient to determine the thermal noise level in the distributed signal path. A W-CDMA base station may be similarly configured.

The present invention may be embodied in other specific forms and implemented by other specific methods without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

We claim:

1. A method for determining characteristics of an antenna path in a base station of a CDMA wireless communications network, including the steps of:
measuring the receive signal power for the antenna path to determine the thermal noise level; and
using the thermal noise level to determine an offset to be applied to communications traffic received via the antenna path.

2. The method as claimed in claim 1 wherein the thermal noise level is determined using a sensor incorporated in the base station circuitry.

3. The method as claimed in claim 1 and including measuring the receive signal power over a time period to obtain a minimum signal.

4. The method as claimed in claim 3 and including storing a value representative of the minimum value of the measured thermal noise level, and changing the stored value changed accordingly if a subsequent lower receive signal power is received.

5. The method as claimed in claim 3 and including generating an alert if the measured thermal noise level deviates from a stored minimum value by more than a pre-set amount.

6. The method as claimed in claim 5 and including sending a notification to a network controller when an alert is generated.

7. The method as claimed in claim 1 and wherein measurements of the receive signal power are not made when communications traffic from or to the base station is being sent via the antenna path.

8. The method as claimed in claim 1 and including storing at the base station a value representative of the measured thermal noise level.

9. The method as claimed 1 and including the steps of:
ascertaining received total wideband power using the measured thermal noise level value; and
reporting received total wideband power to a network controller.

10. A method as claimed in claim 1 and including the steps of:
using a sensor integral with the base station to measure over a time period the thermal noise level in the antenna path when no communications traffic is being transmitted or received along the antenna path and obtaining a minimum value for the measured thermal noise level;
using the minimum value to set an offset to be used in receiving traffic via the antenna path; and
storing a value representative of the minimum value of the measured thermal noise level.

11. A base station for a CDMA wireless communications network, comprising: a measuring circuit including a sensor operative to measure over a time period the thermal noise level in an antenna path to obtain its minimum value; calculating means for calculating an offset using the minimum value; a store for storing a value representative of the minimum value of the thermal noise level; and means for applying the offset to traffic reception via the antenna path.

12. A CDMA wireless network comprising: at least one network controller; and a plurality of base stations, each base station comprising: a measuring circuit including a sensor operative to measure over a time period the thermal noise level in an antenna path to obtain its minimum value; calculating means for calculating an offset using the minimum value; a store for storing a value representative of the minimum value of the thermal noise level; and means for applying the offset to traffic reception via the antenna path, and each base station further comprising means for reporting to the network controller data derived from the measured thermal noise level.

13. A network as claimed in claim 12 and wherein the reported data relates to Received Total Wideband Power.
